(19) United States
(12) Patent Application Publication
(10) Pub. No.: US 2026/0237157 A1
(43) Pub. Date: Aug. 13, 2026

(54) METHOD FOR GENERATING MODEL, ELECTRONIC DEVICE, AND STORAGE MEDIUM

(71) Applicant: NETEASE (HANGZHOU) NETWORK CO., LTD., Hangzhou, Zhejiang (CN)

(72) Inventors: Jie LIANG, Hangzhou, Zhejiang (CN); Zhicong WANG, Guangzhou, Guangdong (CN); Shulong HUANG, Guangzhou, Guangdong (CN)

(73) Assignee: NETEASE (HANGZHOU) NETWORK CO., LTD., Hangzhou, Zhejiang (CN)

(21) Appl. No.: 19/158,059

(22) PCT Filed: Jun. 15, 2023
(86) PCT No.: PCT/CN2023/100516

§ 371 Date: Aug. 20, 2025

(30) Foreign Application Priority Data
Feb. 20, 2023 (CN) 202310180578.9

(51) Int. Cl. G06T 17/20; G06T 7/73; G06T 15/04; G06T 19/20; G06V 40/16

(52) U.S. Cl. CPC G06T 17/20; G06T 7/73; G06T 15/04; G06T 19/20; G06V 40/168; G06T 2207/20132; G06T 2207/30201; G06T 2219/2021; G06T 2219/2024

(57) ABSTRACT

A method for generating a model, an electronic device and a non-transitory computer-readable storage medium are provided. The method includes: acquiring an original image, where the original image includes a face image having an identical artistic style; pre-processing the face image to obtain facial feature data; obtaining, according to a preset template library and the facial feature data, an initial three-dimensional face model corresponding to the face image; extracting, based on the facial feature data and the preset template library, an initial texture map from the face image; and fitting the initial three-dimensional face model and the initial texture map to obtain a target three-dimensional face model.

### CROSS-REFERENCE

The present disclosure is a U.S. National Stage of International Application No. PCT/CN 2023/100516, filed on Jun. 15, 2023, which claims the priority of Chinese Patent Application No. 202310180578.9, entitled “MODEL GENERATION METHOD AND APPARATUS, ELECTRONIC DEVICE, AND STORAGE MEDIUM”, filed on Feb. 20, 2023, the entire content of which are incorporated herein by reference in their entireties.

### TECHNICAL FIELD

The present disclosure relates to a technical field of three-dimensional modeling, and in particular, to a method for generating a model, an apparatus for generating a model, an electronic device, and a non-transitory computer-readable storage medium.

### BACKGROUND

Game players have increasingly higher demands for the attractiveness and diversity of characters in game scenes, and developers need to design and create a large number of character models with different personalities in games to enhance player enjoyment. Specifically, in the demand for stylized face models of game characters, due to the fact that games have different styles, such as classical, Chinese style, martial arts, handsome realistic, and two-dimensional, the requirements for face models vary for different game styles. Furthermore, as the number of face models in a game is relatively small, it is difficult to obtain a large number of face models of the same style by scanning real human faces or using open-source databases. Therefore, producing the face model in the game that highly reproduces the character image in original image has the problems of high development requirements, high production difficulty, and long production cycles.

No solution has yet been proposed for the above problems of low generation efficiency and high development cost of the character face model.

### SUMMARY

Example embodiments of the present disclosure provide a method for generating a model, an apparatus for generating a model, an electronic device, and a non-transitory computer-readable storage medium, thereby at least partially overcoming the problem of low generation efficiency of character face models, which leads to high development cost.

According to an aspect of the present disclosure, there is provided a method for generating a model, including: acquiring an original image, where the original image includes a face image having an identical artistic style; pre-processing the face image to obtain facial feature data; obtaining, according to a preset template library and the facial feature data, an initial three-dimensional face model corresponding to the face image; extracting, based on the facial feature data and the preset template library, an initial texture map from the face image; and fitting the initial three-dimensional face model and the initial texture map to obtain a target three-dimensional face model.

According to an aspect of the present disclosure, there is further provided an electronic device, including: a processor; and a memory, where the memory stores computer-readable instructions which, when executed by the processor, implement the method for generating a model according to any of the above.

According to an aspect of the present disclosure, there is further provided a non-transitory computer-readable storage medium storing a computer program, where the computer program, when executed by a processor, implements the method for generating a model according to any of the above.

### BRIEF DESCRIPTION OF THE DRAWINGS

FIG. 1 is a schematic diagram of an exemplary system architecture of a method and an apparatus for generating a model according to an embodiment of the present disclosure;

FIG. 2 schematically illustrates a flow diagram of a method for generating a model according to some embodiments of the present disclosure;

FIG. 3 schematically illustrates facial feature points according to some embodiments of the present disclosure;

FIG. 4 schematically illustrates a first example of a target three-dimensional face model according to some embodiments of the present disclosure;

FIG. 5 schematically illustrates a second example of a target three-dimensional face model according to some embodiments of the present disclosure;

FIG. 6 schematically illustrates an apparatus for generating a model according to some embodiments of the present disclosure;

FIG. 7 schematically illustrates a structural diagram of a computer system of an electronic device according to some embodiments of the present disclosure.

### DETAILED DESCRIPTION

The embodiments will now be described more fully with reference to the accompanying drawings. However, the embodiments may be implemented in many different forms and should not be construed as being limited to the examples set forth herein; rather, these embodiments are provided such that the present disclosure will be thorough and complete, and such that the concept of the embodiments will be fully conveyed to those skilled in the art.

Furthermore, the described features, structures, or characteristics may be combined in any suitable manner in one or more embodiments. In the following description, numerous specific details are provided to give a thorough understanding of the embodiments of the present disclosure. However, those skilled in the art will recognize that the technical solutions of the present disclosure may be practiced without one or more of the specific details, or that other methods, components, devices, steps, and the like may be employed. In other instances, well-known methods, devices, implementations, or operations are not shown or described in detail to avoid obscuring aspects of the present disclosure.

In addition, the drawings are merely illustrative diagrams and are not necessarily drawn to scale. The block diagrams shown in the drawings are merely functional entities and are not necessarily required to correspond to physically independent entities. That is, these functional entities may be implemented in the form of software, or implemented in one or more hardware modules or integrated circuits, or implemented in different networks and/or processor devices and/or microcontroller devices.

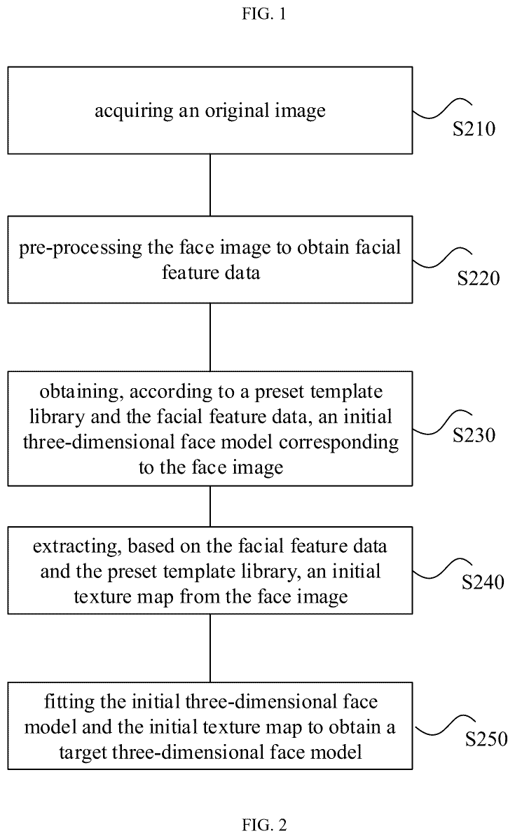

FIG. 1 illustrates a schematic diagram of a system architecture of a method and an apparatus for generating a model applicable to embodiments of the present disclosure.

As shown in FIG. 1, the system architecture 100 may include one or more of terminal devices 101, 102, and 103, a network 104, and a server 105. The network 104 is used to provide a communication link medium between the terminal devices 101, 102, and 103 and the server 105. The network 104 may include various connection types, such as wired, wireless communication links, or fiber optic cables, and the like. The terminal devices 101, 102, and 103 may be various electronic devices having a display screen, including but not limited to desktop computers, portable computers, smartphones, and tablet computers, and the like. It should be understood that the numbers of terminal devices, networks, and servers in FIG. 1 are merely illustrative. Any number of terminal devices, networks, and servers may be provided as needed for implementation. For example, the server 105 may be a server cluster composed of a plurality of servers.

The method for generating the model provided in the embodiments of the present disclosure may be executed by the terminal devices 101, 102, and 103, and correspondingly, the apparatus for generating the model may also be disposed in the terminal devices 101, 102, and 103. The method for generating the model provided in the embodiments of the present disclosure may also be executed jointly by the terminal devices 101, 102, and 103 and the server 105, and correspondingly, the apparatus for generating the model may be disposed in the terminal devices 101, 102, and 103 and the server 105. In addition, the method for generating the model provided in the embodiments of the present disclosure may also be executed by the server 105, and correspondingly, the apparatus for generating the model may be disposed in the server 105, which is not limited in the present embodiments.

For example, in the present embodiment, an original image may be acquired, which is received by the server 105 deployed on a game platform through input from the terminal devices 101, 102, and 103; then, the face image is pre-processed to obtain facial feature data; an initial three-dimensional face model corresponding to the face image is obtained according to a preset template library and the facial feature data; thereafter, the server 105 continues to extract an initial texture map from the face image based on the facial feature data and the preset template library; and the initial three-dimensional face model and the initial texture map are fitted to obtain a target three-dimensional face model.

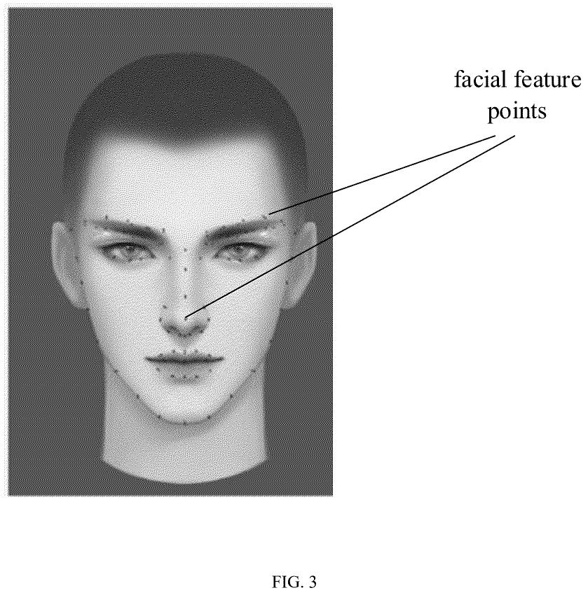

However, it will be readily understood by those skilled in the art that the above operations are merely illustrative, and are not intended to limit the present embodiment. In one embodiment of the present disclosure, the method for generating the model may be run on a terminal device or a server. The following will take the execution of the method for generating the model of the present disclosure on a server as an example for illustration. FIG. 2 schematically shows a schematic diagram of a method for generating a model according to some embodiments of the present disclosure. Referring to FIG. 2, the method for generating the model may include the following steps S210-S250:
in step S210, an original image is acquired, where the original image includes a face image having an identical artistic style.

The original image acquired from a computer web client or a mobile client may be an original image in a game scene, an original image in an animation scene, or an original image in a two-dimensional scene. The present disclosure is not limited thereto.

Specifically, the artistic style may be a Chinese style, a martial arts style, a handsome realistic style, or a two-dimensional style.

For example, the acquired original image may be an original image having a Chinese style in a game scene. Of course, the acquired original image may also be an original image having a martial arts style in an animation scene, or an original image having a two-dimensional style in a two-dimensional scene. Further for example, the original image may include a face image of a game having a Chinese style in a game scene, or may include a face image having a two-dimensional style in a two-dimensional scene. The present disclosure is not limited thereto.

Next, the present disclosure will be described in detail by taking as an example acquiring a game face image in a game original image in a game scene.
in step S220, the face image is pre-processed to obtain facial feature data.

The face image in the original image of the game scene, received as input from a computer client or a mobile client, is pre-processed to obtain the facial feature data. The pre-processing operation may include: performing feature point detection on the game original face, performing cropping on the game original face, and performing segmentation on the game original face. The facial feature data may be data of a facial organ of a human face, or may be a facial feature point of a human face. It should be noted that, depending on the type of original image, the pre-processing operation of the present disclosure is not limited to the above operation modes, and will not be described in detail herein.

In an embodiment of the present disclosure, the facial feature data includes a facial feature point of the face image, and pre-processing the face image to obtain the facial feature data includes: labeling the facial feature point of the face image according to a topological wiring of the identical artistic style to obtain labeled data; adjusting a pre-trained initial face feature point detection model according to the labeled data to obtain an adjusted target face feature point detection model; and inputting the face image into the target face feature point detection model to obtain the facial feature point.

For example, first, a basic real-time face feature point detection model (corresponding to the initial face feature point detection model in the present disclosure) is pre-trained based on MobileNet using the 300W-LP dataset, the feature point corresponding to the face image of the original image is labeled according to the topological wiring of the game character, to obtain labeled data. Then, a labeled dataset is constructed according to the labeled data, and the initial face feature point detection model is retrained and adjusted according to the labeled dataset to obtain a target face feature point detection model. Finally, the face image is input into the target face feature point detection model to obtain the facial feature point required by the present disclosure, where an image of the facial feature points may be as shown by the points on the character's face in the example of FIG. 3. By adjusting the pre-trained initial face feature point detection model, the present disclosure achieves more accurate detection of facial feature point in the original image.

It should be noted that, in the present disclosure, the facial feature point automatically detected may be manually adjusted by operation and maintenance personnel, such that the obtained facial feature point is more accurate. The higher the accuracy of the feature point, the more accurate the shape of the subsequently reconstructed target three-dimensional face model is.

In an embodiment of the present disclosure, the facial feature data includes facial organ feature data of the face image, and pre-processing the face image to obtain the facial feature data includes: cropping the face image according to the facial feature point, to obtain a cropped face image; detecting pixel coordinate information of a facial organ in the cropped face image; and taking the pixel coordinate information as the facial organ feature data.

For example, after detecting the facial feature points through the target face feature point detection model, the present disclosure clips out a unified face region according to the obtained facial feature point in combination with a cropping rule, and scales the face region to a size of 300×300 pixels, to obtain the cropped face image in the present disclosure. Thereafter, by using an existing open-source facial semantic segmentation algorithm, the pixel positions corresponding to different facial organs in the cropped face image are detected and recorded, and the pixel positions corresponding to different facial organs are taken as the facial organ feature data. The facial organ feature data mainly includes pixel positions of left and right eyes, pixel positions of an unobstructed skin region of the face, pixel positions of upper and lower lips, pixel positions of left and right eyebrows, pixel positions of hair and other occlusion regions, and pixel positions of a background region. By detecting the facial organ feature data, the present disclosure enables more efficient and accurate generation of the subsequent target three-dimensional face model, and reduces the development cost.

In step S230, an initial three-dimensional face model corresponding to the face image is obtained according to a preset template library and the facial feature data.

In order to improve the generation efficiency of the target three-dimensional face model and reduce the development cost, before obtaining the initial three-dimensional face model corresponding to the face image according to the preset template library and the facial feature data, the construction of the preset template library is also one of the inventive aspects of the present disclosure. The specific implementation steps include: acquiring historical character face model data, and performing retopology on the topological wiring in the historical character face model data to obtain retopologized character face model data; calculating a character facial region in the retopologized character face model data; recombining and splicing the historical character face model data through a mesh of the character facial region, to obtain expanded character face model data, where a character artistic style in the historical character face model data is identical to a character artistic style in the expanded character face model data; and constructing the preset template library according to the historical character face model data and the expanded character face model data.

For example, the historical face model data having a handsome and realistic style in a game scene may be acquired, or historical face model data having a Chinese style in a game scene may be acquired, and the present disclosure is not limited thereto. Taking the acquisition of the historical face model data having the Chinese style as an example, the historical face model data includes 20 small-sample face model datasets. By performing topological alignment of the facial topological wiring in the 20 small-sample face model datasets to unify the face model wiring, 20 topologically processed small-sample character face model datasets are obtained. According to the corresponding relationships of point cloud positions, the texture map under the unified new wiring is re-rendered and generated, Procrustes analysis is performed to orient and align the existing models, the facial organ region in the texture map (i.e., UV map) is divided and reverse indexing is performed to find the mesh of the corresponding facial organ part in the three-dimensional point cloud. By cross-splicing meshes of different facial organ regions according to different rules, the original 20 small-sample face model datasets are expanded into a plurality of expanded character face model data having the same Chinese style, and the facial organ regions in the maps are segmented, cross-mixed, seamlessly spliced to generate more new texture maps to expand diversity, such that the character artistic style in the historical character face model data is identical to the character artistic style in the expanded character face model data, by constructing the preset template library, the present disclosure, while improving the diversity of face model resources, also enhances the generation efficiency of the subsequent target three-dimensional face model and reduces the development cost.

For example, the specific recombination and splicing technology may be implemented by the following steps: calculating symmetric points of the small-sample face model data to correct the symmetry of the retopologized model; calculating an average face model (corresponding to the average face model in the present disclosure) from all face models in the small-sample face model data; labeling 86 three-dimensional feature points corresponding to semantics; determining variable and invariable regions of the small-sample face model data to facilitate reuse of accessories such as a body, a neck or a hairstyle to reduce the seam; extracting principal components based on the PCA (Principal Component Analysis) processing of the enhanced model to construct a shape basis of a 3DMM (3D Morphable Face Model, hereinafter referred to as 3DMM); removing a UV mask (i.e., UV Mask) that delineates parts such as the eyes which only affect the face; counting the texture pixel positions at specified high and low resolutions; performing PCA processing at these pixel positions based on the expanded texture map to extract the principal components, and constructing the texture basis of the 3DMM, so as to obtain the expanded character face model data. Through the construction of the preset template library, the present disclosure improves the diversity of face model resources, while enhancing the subsequent generation efficiency of the target three-dimensional face model and reducing the development cost.

In an embodiment of the present disclosure, the preset template library includes: a shape basis and an average face model, and obtaining the initial three-dimensional face model corresponding to the face image according to the preset template library and the facial feature data includes: acquiring the shape basis and the average face model in the preset template library; fitting the shape basis and the facial feature point to obtain a target shape basis; and iteratively calculating the target shape basis and the average face model to obtain the initial three-dimensional face model.

For example, in the present disclosure, the shape basis is used to represent a shape of the face model, and a shape basis coefficient is used to control the facial shape of a character; the texture basis is used to represent a texture color of the face, and the texture basis coefficient is used to render the face with different colors. The present disclosure, based on the Gauss-Newton iteration approach, the shape of the face model and the pose parameter such as pose and orientation are firstly preliminarily calculated based on the detected facial feature point and the preset template library. For example, the shape basis and the texture basis, as well as the average face model, mesh symmetry points, variable and fixed regions, connection regions, boundary point sequences, and other facial features, may be calculated from the face model data in the preset template library, and these facial features are added into the template library. The shape basis and the average face model in the preset template library are acquired; the shape basis in the preset template library is fitted to the facial feature points to obtain a target shape basis, and an iterative computation is performed based on the average face model to obtain the initial three-dimensional face model. The specific fitting principle is implemented by iteratively calculating the shape basis coefficient and the projection pose parameter. When the pose calculation is performed, a perspective projection mode or an orthographic projection mode may be specified, such that the positions of the feature points in the reconstructed shape projection are as close as possible to the positions of the facial feature points directly detected in the original image. The initial three-dimensional face model obtained in the present disclosure at least includes parameters such as the initial face model shape and projection pose, and the model shape already has a good correspondence with the original image, thereby further improving the generation efficiency of the subsequent target three-dimensional face model.

In step S240, an initial texture map is extracted from the face image based on the facial feature data and the preset template library.

Specifically, the texture basis coefficient of the initial texture is obtained through the facial organ feature data in the facial feature data and the preset template library, and the initial texture map is further obtained.

In an embodiment of the present disclosure, the preset template library further includes: a texture basis, and extracting the initial texture map from the face image based on the facial feature data and the preset template library includes: performing projection mapping in the face image based on the initial three-dimensional face model and the facial organ feature data, to extract a two-dimensional texture map in the face image; calculating an initial texture basis coefficient according to the two-dimensional texture map and the texture basis in the preset template library; and determining the initial texture map according to the initial texture basis coefficient.

In this solution, the initial three-dimensional model is first projected into the face image in the original image to extract the two-dimensional texture map in the face image, and the face region is cropped out by using the mask of the facial organ feature data obtained in the above steps. Then, by iteratively fitting the two-dimensional texture map and the texture basis in the preset template library through gradual computation, the texture basis coefficient of the initial texture map is obtained, such that the pixels at the corresponding positions between the fitted texture and the extracted two-dimensional texture map are as consistent as possible. By obtaining a relatively good initial texture basis coefficient, the present disclosure ensures that the subsequent texture refinement step in the differentiable rendering optimization process may be efficiently completed.

In step S250, the initial three-dimensional face model and the initial texture map are fitted to obtain a target three-dimensional face model.

In an embodiment of the present disclosure, the initial three-dimensional face model includes a three-dimensional face shape, and fitting the initial three-dimensional face model and the initial texture map to obtain the target three-dimensional face model includes: calculating a shape image loss between the three-dimensional face shape and the face image; calculating a texture image loss between the initial texture map and the face image; determining a shape basis coefficient of the target three-dimensional face model according to the shape image loss and the texture image loss; updating the three-dimensional face shape and the initial texture map according to the shape basis coefficient to obtain a refined texture basis coefficient; and determining the target three-dimensional face model according to the refined texture basis coefficient.

For example, in the step of obtaining the target three-dimensional face model based on refined shape reconstruction of a differentiable rendering framework, the 3DMM basis coefficient calculated as results from step S230 and step S240 are used as inputs, and the texture image loss and the shape image loss are obtained by combining, through differentiable rendering, the image pixel loss (hereinafter referred to as “loss”) of a visible facial region of the three-dimensional face shape, for example, the loss obtained by comparing the three-dimensional face shape, after being illumination-rendered, with the original face image. The texture image loss is used to compare the texture consistency between the initial three-dimensional face model and the original face image; the smaller the texture image loss, the better the robustness of the initial three-dimensional face model. Therefore, the original face image needs to be slightly blurred to prevent the overfitting loss. The shape image loss is used to compare the shape consistency between the initial three-dimensional face model and the original face image; the smaller the shape image loss, the better the robustness of the initial three-dimensional face model. In addition, the related loss of the 3DMM basis regularization term is obtained, and the related loss and the above-obtained shape image loss and texture image loss are weighted with different weights to construct a final loss, so as to fit and solve for a more refined texture basis coefficient. That is, in the present disclosure, the refined texture basis coefficient is obtained based on the loss weighted by different weights. Then, the target three-dimensional face model is obtained according to the refined texture basis coefficient. By solving the shape basis coefficient and the texture basis coefficient, the present disclosure improves the matching between the target three-dimensional face model and the two-dimensional original image.

In an embodiment of the present disclosure, the face image includes a face image under at least one view angle, the shape image loss includes a shape image loss corresponding to the face image under the at least one view angle, and the texture image loss includes a texture image loss corresponding to the face image under the at least one view angle, where the view angle includes at least one of: a front view angle, a left view angle, or a right view angle.

For example, the face image in the original image may include not only a face image with a front view angle, but also a face image with a left view angle and a face image with a right view angle. In the initial texture fitting stage, the textures corresponding to the three images are respectively extracted, and the corresponding regions are fused through visibility calculation to obtain an initial texture map, which is then fitted. In the differentiable rendering fitting stage, the shape image loss and the texture image loss under different view angles need to be respectively calculated, and the pixel loss and face recognition loss of images rendered synchronously for other corresponding view angles and the original image are added. Moreover, the more original images with view angles are input, the higher the fitting reconstruction accuracy is. Therefore, the present disclosure may obtain a more accurate target three-dimensional face model through a plurality of constraints of a plurality of original images.

In an embodiment of the present disclosure, the preset template library further includes a fixed region, and fitting the initial three-dimensional face model and the initial texture map to obtain the target three-dimensional face model includes: fitting the initial three-dimensional face model and the initial texture map to obtain an intermediate three-dimensional face model; connecting a fixed facial region in the intermediate three-dimensional face model with a fixed human body model to obtain a connected region, and performing deformation processing on the connected region to obtain a target intermediate three-dimensional face model; determining a movement position of a facial organ model in the target intermediate three-dimensional face model to obtain pose data of the facial organ model; and adjusting the target intermediate three-dimensional face model according to the connected region and the pose data to obtain the target three-dimensional face model.

For example, optimizing and fitting the initial three-dimensional face model and the initial texture map to obtain the intermediate three-dimensional face model, belongs to an upper-level model optimization process of the step of obtaining the target three-dimensional face model. Specifically, a fixed facial region in the intermediate three-dimensional face model is connected with a fixed human body model, and the connected region is performed with the deformation processing to obtain a target intermediate three-dimensional face model with a unified connected region, where the above-mentioned fixed region includes the fixed facial region and the fixed human body model, which may be a skull region (or cranium region), a neck region, or a hair region. In this case, a ring of points at the junction between the skull and the face is aligned to the specified anchor point position corresponding to the seam points through Procrustes analysis, and the facial region deformation is directly achieved by pulling, followed by splicing the non-variable region. In this process, in order to reduce the impact on the facial organ model, a region of the facial organ model is designated in advance so as to increase the shape constraint weight during Laplacian pulling. The facial organ model includes: eyes, eyeballs, eyelashes, eyebrows, ears, nose, and other organ features. For example, by calculating the translation position from the center point of the eyeball, and calculating the rotation and scaling for placing the eyeball from the edge points of the eyeball frame and the eye socket points, the eyeball pose data is obtained. In addition, in the present disclosure, the upper and lower eyelashes may be preliminarily placed through Iterative Closest Point (ICP) registration approach according to the corresponding feature points, and seamless texture splicing of components such as the eyeball may be performed by removing defects from invisible defective regions for refined post-processing, and the tone of the unified texture map may be replaced. Based on the deformed connected region, the eyeball displacement data, the processing of the eyelashes, and the processing of the texture, the intermediate three-dimensional face model is adjusted, thereby obtaining a more refined target three-dimensional face model while also improving the generation efficiency of the target three-dimensional face model.

In an embodiment of the present disclosure, fitting the initial three-dimensional face model and the initial texture map to obtain the target three-dimensional face model includes: acquiring an initial texture basis coefficient; determining an initial texture map through the initial texture basis coefficient; fitting the initial texture map and the initial three-dimensional face model to obtain a target texture map; if a style of the target three-dimensional face model is a preset style, refining the target texture map according to a texture model to obtain a refined texture map, where an accuracy of the refined texture map is higher than an accuracy of the target texture map; and determining the target three-dimensional face model according to the refined texture map.

Specifically, the initial texture map is generated through the initial texture basis coefficient, and the initial texture map is fitted with the initial three-dimensional face model to obtain the target texture map. In a case where the preset game style is a non-two-dimensional style (corresponding to the preset style in the present disclosure), the target texture map is iteratively optimized based on a pix2pix (a network structure for image-to-image used for image generation) model (i.e., the texture model), specifically by constructing corresponding paired data to refine the target texture map, so as to obtain the refined texture map, where the iterative optimization process of refinement may be performed by processing the texture clarity of the target texture map to obtain a higher-definition refined texture map. Then, the target three-dimensional face model and the obtained refined texture map are combined, such that the efficiently generated target three-dimensional face model is more accurate.

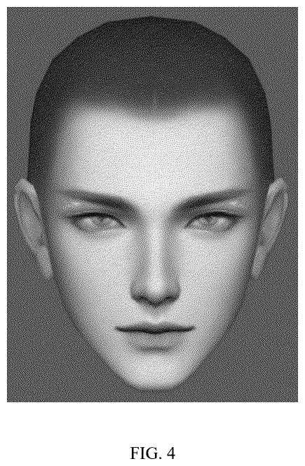

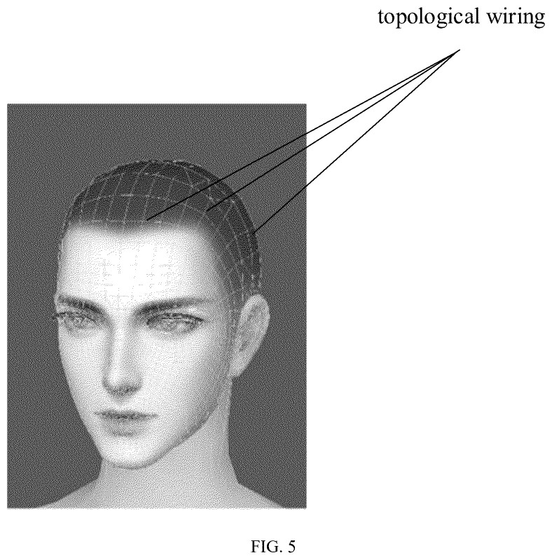

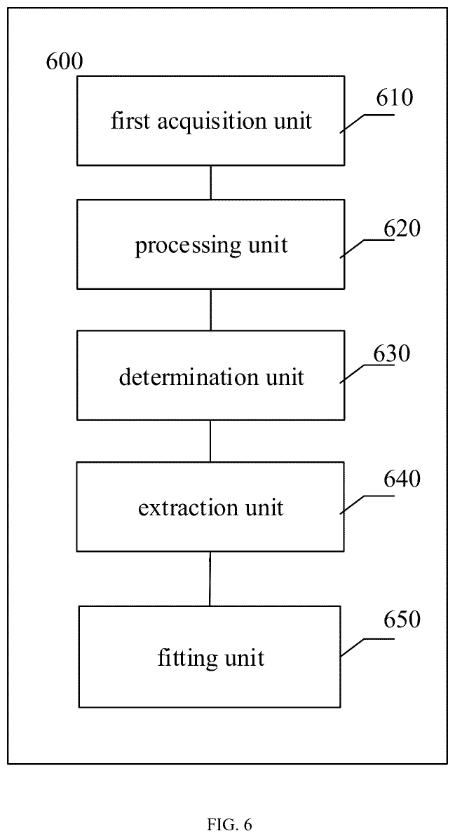

It should be noted that the target three-dimensional face model in the present disclosure may be a face model in a frontal view as shown in FIG. 4, or may be a face model in a side view as shown in FIG. 5, which is not limited herein. FIG. 5 includes a topological wiring of the model.

In summary, according to the method for generating the model in the embodiment, the original image is acquired, where the original image includes a face image having the identical artistic style; the face image is pre-processed to obtain the facial feature data; the initial three-dimensional face model corresponding to the face image is obtained according to the preset template library and the facial feature data; the initial texture map is extracted from the face image based on the facial feature data and the preset template library; and the initial three-dimensional face model and the initial texture map are fitted to obtain the target three-dimensional face model. On one hand, by obtaining the initial three-dimensional face model corresponding to the face image according to the preset template library and the facial feature data, the parameter and the image feature point position may be quickly adjusted according to the initial model, thereby improving the generation efficiency of the initial three-dimensional face model; on the other hand, by fitting the initial three-dimensional face model and the initial texture map, the accuracy of the target three-dimensional face model is improved.

It should be noted that although the respective steps of the method in the present disclosure are described in a specific order in the drawings, this does not require or imply that these steps must be performed in that specific order, or that all illustrated steps must be performed to achieve the desired result. Additionally or alternatively, some steps may be omitted, multiple steps may be combined into one step for execution, and/or one step may be decomposed into multiple steps for execution, etc.

In addition, in the embodiment, an apparatus for generating a model is also provided. Referring to FIG. 6, the apparatus for generating the model 600 includes a first acquisition unit 610, a processing unit 620, a determination unit 630, an extraction unit 640, and a fitting unit 650.

Specifically, the first acquisition unit 610 is configured to acquire an original image, where the original image includes a face image having the identical artistic style;
the processing unit 620 is configured to preprocess on the face image to obtain facial feature data;
the determination unit 630 is configured to obtain an initial three-dimensional face model corresponding to the face image according to a preset template library and the facial feature data;
the extraction unit 640 is configured to extract an initial texture map from the face image based on the facial feature data and the preset template library;
the fitting unit 650 is configured to fit the initial three-dimensional face model and the initial texture map to obtain a target three-dimensional face model.

In summary, in the present disclosure, the first acquisition unit 610 acquires the original image, where the original image includes the face image having the identical artistic style; the processing unit 620 performs preprocessing on the face image to obtain the facial feature data; the determination unit 630 obtains the initial three-dimensional face model corresponding to the face image according to the preset template library and the facial feature data; the extraction unit 640 extracts the initial texture map from the face image based on the facial feature data and the preset template library; and the fitting unit 650 fits the initial three-dimensional face model and the initial texture map to obtain the target three-dimensional face model. On one hand, by obtaining the initial three-dimensional face model corresponding to the face image according to the preset template library and the facial feature data, the diversity of template data in the open-source database is increased, the generation efficiency of the initial three-dimensional face model is also improved, the processing efficiency of the apparatus for generating the model is improved, and related computing resources are saved; on the other hand, by fitting the initial three-dimensional face model and the initial texture map, the accuracy of the target three-dimensional face model is improved.

In some embodiments, the facial feature data includes a facial feature point of the face image, and the processing unit includes: a labeling module, configured to label the facial feature point of the face image according to a topological wiring of the identical artistic style, so as to obtain labeled data; an adjustment module, configured to adjust a pre-trained initial face feature point detection model according to the labeled data, so as to obtain an adjusted target face feature point detection model; and an input module, configured to input the face image into the target face feature point detection model to obtain the facial feature point.

In some embodiments, the facial feature data includes organ feature data of the face image, and the processing unit includes: a cropping module, configured to crop the face image according to the facial feature points, so as to obtain a cropped face image; a detection module, configured to detect pixel coordinate information of a facial organ in the cropped face image; and a first determination module, configured to take the pixel coordinate information as the facial organ feature data.

In some embodiments, the apparatus further includes: a second acquisition unit, configured to, before obtaining the initial three-dimensional face model corresponding to the face image according to the preset template library and the facial feature data, acquire historical character face model data, and perform retopology on topological wiring in the historical character face model data, so as to obtain retopologized character face model data; a calculation unit, configured to calculate a character facial region in the retopologized character face model data; a reorganization unit, configured to recombine and splice the historical character face model data through a mesh of the character facial region, so as to obtain expanded character face model data, where a character artistic style in the historical character face model data is the same as a character artistic style in the expanded character face model data; and a construction unit, configured to construct the preset template library according to the historical character face model data and the expanded character face model data.

In some embodiments, the preset template library includes: a shape basis and an average face model, and the determination unit includes: a first acquisition module, configured to acquire the shape basis and the average face model from the preset template library; a first fitting module, configured to fit the shape basis with the facial feature point to obtain a target shape basis; and an iteration module, configured to iteratively calculate the target shape basis and the average face model to obtain the initial three-dimensional face model.

In some embodiments, the preset template library further includes: a texture basis, and the extraction unit includes: an extraction module, configured to perform projection mapping in the face image based on the initial three-dimensional face model and the facial organ feature data, so as to extract a two-dimensional texture map in the face image; a first calculation module, configured to calculate an initial texture basis coefficient according to the two-dimensional texture map and the texture basis in the preset template library; and a second determination module, configured to determine the initial texture map according to the initial texture basis coefficient.

In some embodiments, the initial three-dimensional face model includes a three-dimensional face shape, and the fitting unit includes: a second calculation module, configured to calculate a shape image loss between the three-dimensional face shape and the face image; a third calculation module, configured to calculate a texture image loss between the initial texture map and the face image; to determine a shape basis coefficient of the target three-dimensional face model according to the shape image loss and the texture image loss; an update module, configured to update the three-dimensional face shape and the initial texture map according to the shape basis coefficient to obtain a refined texture basis coefficient; and a third determination module, configured to determine the target three-dimensional face model according to the refined texture basis coefficient.

In some embodiments, the face image includes a face image under at least one view angle, the shape image loss includes a shape image loss corresponding to the face image under at least one view angle, and the texture image loss includes a texture image loss corresponding to the face image under the at least one view angle, where the view angle includes at least one of: a front view angle, a left view angle, or a right view angle.

In some embodiments, the preset template library further includes a fixed region, and the fitting unit includes: a second fitting module, configured to fit the initial three-dimensional face model and the initial texture map to obtain an intermediate three-dimensional face model; a first processing module, configured to connect a fixed facial region in the intermediate three-dimensional face model with a fixed human body model to obtain a connected region, and perform deformation processing on the connected region to obtain a target intermediate three-dimensional face model; a fourth determination module, configured to determine a movement position of a facial organ model in the target intermediate three-dimensional face model to obtain pose data of the facial organ model; and an adjustment module, configured to adjust the target intermediate three-dimensional face model according to the connected region and the pose data to obtain the target three-dimensional face model.

In some embodiments, the fitting unit includes: a second acquisition module, configured to acquire an initial texture basis coefficient; a fifth determination module, configured to determine the initial texture map according to the initial texture basis coefficient; a third fitting module, configured to fit the initial texture map and the initial three-dimensional face model to obtain a target texture map; a second processing module, configured to, if a style of the target three-dimensional face model is a preset style, perform refinement processing on the target texture map according to a texture model to obtain a refined texture map, where an accuracy of the refined texture map is higher than that of the target texture map; and a fourth fitting module, configured to determine the target three-dimensional face model according to the refined texture map.

The specific details of each module of the apparatus for generating the model described above have already been described in detail in the corresponding model generation method, and thus will not be repeated here.

It should be noted that although several modules or units for performing actions have been mentioned in the above detailed description, such a division is not mandatory. In fact, according to the embodiments of the present disclosure, the features and functions of two or more modules or units described above may be embodied in one module or unit. Conversely, the features and functions of one module or unit described above may be further divided and embodied by multiple modules or units.

In addition, although the steps of the method in the present disclosure are described in a specific order in the accompanying drawings, this does not require or imply that these steps must be performed in this specific order, or that all the illustrated steps must be performed to achieve the desired result. Additionally or alternatively, some steps may be omitted, multiple steps may be combined and executed as one step, and/or one step may be decomposed and executed as multiple steps.

Through the description of the above embodiments, those skilled in the art may easily understand that the embodiments described herein may be implemented by software, or by software in combination with necessary hardware. Therefore, the technical solutions of the embodiments of the present disclosure may be embodied in the form of a software product, which may be stored in a non-volatile storage medium (which may be a CD-ROM, a USB flash drive, a mobile hard disk, etc.) or on a network, and includes several instructions for enabling a computing device (which may be a personal computer, a server, a mobile terminal, or a network device, etc.) to execute the method according to the embodiments of the present disclosure.

In the embodiment of the present disclosure, a non-transitory computer storage medium capable of implementing the above method is also provided. A program product capable of implementing the above method of this specification is stored thereon. In some possible embodiments, various aspects of the present disclosure may also be implemented in the form of a program product, which includes program code. When the program product runs on a terminal device, the program code is used to cause the terminal device to execute the steps described in the “exemplary method” section above of this specification according to various embodiments of the present disclosure, for example, performing the following steps: acquiring the original image, where the original image includes a face image having the initial artistic style; pre-processing the face image to obtain facial feature data; obtaining the initial three-dimensional face model corresponding to the face image according to a preset template library and the facial feature data; extracting an initial texture map from the face images based on the facial feature data and the preset template library; and fitting the initial three-dimensional face model and the initial texture map to obtain a target three-dimensional face model.

On one hand, by obtaining the initial three-dimensional face model corresponding to the face image according to the preset template library and the facial feature data, the diversity of template data in the open-source database is increased, and the generation efficiency of the initial three-dimensional face model is improved, the processing efficiency of the computer storage medium is enhanced, and the related computing resources are saved; on the other hand, by fitting the initial three-dimensional face model and the initial texture map, the accuracy of the target three-dimensional face model is improved.

In some embodiments, the facial feature data includes a facial feature point of the face image, and pre-processing the face image to obtain the facial feature data includes: labeling the facial feature point of the face image according to a topological wiring of the identical artistic style to obtain labeled data; adjusting a pre-trained initial facial feature point detection model according to the labeled data to obtain an adjusted target facial feature point detection model; and inputting the face image into the target facial feature point detection model to obtain the facial feature point.

In some embodiments, the facial feature data includes facial organ feature data of the face image, and pre-processing the face image to obtain the facial feature data includes: cropping the face image according to the facial feature point to obtain a cropped face image; detecting pixel coordinate information of a facial organ in the cropped face image; and taking the pixel coordinate information as the facial organ feature data.

In some embodiments, before obtaining the initial three-dimensional face model corresponding to the face image according to the preset template library and the facial feature data, the method further includes: acquiring historical character face model data, and performing retopology on the topological wiring in the historical character face model data to obtain retopologized character face model data; calculating a character facial region in the retopologized character face model data; recombining and splicing the historical character face model data through a mesh of the character facial region to obtain expanded character face model data, where the character artistic style in the historical character face model data is the same as that of the expanded character face model data; and constructing the preset template library according to the historical character face model data and the expanded character face model data.

In some embodiments, the preset template library includes: a shape basis and an average face model, and obtaining the initial three-dimensional face model corresponding to the face image according to the preset template library and the facial feature data includes: acquiring the shape basis and the average face model in the preset template library; fitting the shape basis and the facial feature points to obtain a target shape basis; and iteratively calculating the target shape basis and the average face model to obtain the initial three-dimensional face model.

In some embodiments, the preset template library further includes: a texture basis, and extracting the initial texture map from the face image based on the facial feature data and the preset template library includes: performing projection mapping in the face image based on the initial three-dimensional face model and the facial organ feature data to extract a two-dimensional texture map in the face image; calculating an initial texture basis coefficient according to the two-dimensional texture map and the texture basis in the preset template library; and determining the initial texture map according to the initial texture basis coefficient.

In some embodiments, the initial three-dimensional face model includes a three-dimensional face shape, and fitting the initial three-dimensional face model and the initial texture map to obtain a target three-dimensional face model includes: calculating a shape image loss between the three-dimensional face shape and the face image; calculating a texture image loss between the initial texture map and the face image; determining a shape basis coefficient of the target three-dimensional face model according to the shape image loss and the texture image loss; updating the three-dimensional face shape and the initial texture map according to the shape basis coefficient to obtain a refined texture basis coefficient; and determining the target three-dimensional face model according to the refined texture basis coefficient.

In some embodiments, the face image includes a face image under at least one view angle, the shape image loss includes a shape image loss corresponding to the face image under the at least one view angle, and the texture image loss includes a texture image loss corresponding to the face image under the at least one view angle, where the view angle includes at least one of: a front view angle, a left view angle, and a right view angle.

In some embodiments, the preset template library further includes a fixed region, and fitting the initial three-dimensional face model and the initial texture map to obtain the target three-dimensional face model includes: fitting the initial three-dimensional face model and the initial texture map to obtain an intermediate three-dimensional face model; connecting a fixed facial region in the intermediate three-dimensional face model with a fixed human body model to obtain a connected region; performing deformation processing on the connected region to obtain a target intermediate three-dimensional face model; determining a movement position of a facial organ model in the target intermediate three-dimensional face model to obtain pose data of the facial organ model; and adjusting the target intermediate three-dimensional face model according to the connected region and the pose data to obtain the target three-dimensional face model.

In some embodiments, fitting the initial three-dimensional face model and the initial texture map to obtain the target three-dimensional face model includes: acquiring the initial texture basis coefficient; determining an initial texture map through the initial texture basis coefficient; fitting the initial texture map and the initial three-dimensional face model to obtain a target texture map; if the style of the target three-dimensional face model is a preset style, refining the target texture map according to a texture model to obtain a refined texture map, where the accuracy of the refined texture map is higher than that of the target texture map; and determining the target three-dimensional face model according to the refined texture map.

In some embodiments, the embodiments of the present disclosure may further include a program product for implementing the above method, which may adopt a compact disc read-only memory (CD-ROM) and include program code, and may run on a terminal device such as a personal computer. However, the program product of the present disclosure is not limited thereto. In the present disclosure, a readable storage medium may be any tangible medium that contains or stores a program, which may be used by, or in combination with, an instruction execution system, apparatus, or device.

The program product may adopt any combination of one or more readable medium. The readable medium may be a readable signal medium or a readable storage medium. The readable storage medium may be, but is not limited to, an electrical, magnetic, optical, electromagnetic, infrared, or semiconductor system, apparatus, or device, or any combination of the foregoing. More specific examples of the readable storage medium (a non-exhaustive list) include: an electrical connection having one or more wires, a portable disc, a hard disk, a random access memory (RAM), a read-only memory (ROM), an erasable programmable read-only memory (EPROM or flash memory), an optical fiber, a compact disc read-only memory (CD-ROM), an optical storage device, a magnetic storage device, or any suitable combination of the foregoing.

A computer-readable signal medium may include a data signal propagated in baseband or as part of a carrier, carrying a readable program code. Such a propagated data signal may take many forms, including but not limited to an electromagnetic signal, an optical signal, or any suitable combination of the foregoing. The readable signal medium may also be any readable medium other than a readable storage medium, which may send, propagate, or transmit a program to be used by, or in combination with, an instruction execution system, apparatus, or device.

The program code contained on the readable medium may be transmitted using any appropriate medium, including but not limited to wireless, wired, optical cable, RF, or any suitable combination of the foregoing.

The program code for performing the operations of the present disclosure may be written in any combination of one or more programming languages, including object-oriented programming languages-such as Java, C++, and the like-as well as conventional procedural programming languages-such as the “C” language or similar programming languages. The program code may execute entirely on the user's computing device, partly on the user's computing device, as a standalone software package, partly on the user's computing device and partly on a remote computing device, or entirely on the remote computing device or server. In scenarios involving a remote computing device, the remote computing device may be connected to the user's computing device through any type of network, including a local area network (LAN) or a wide area network (WAN), or may be connected to an external computing device (for example, via the Internet using an Internet service provider).

In addition, in an embodiment of the present disclosure, an electronic device capable of implementing the above method is also provided.

Those skilled in the art may understand that the various aspects of the present disclosure may be implemented as a system, a method, or a program product. Therefore, the various aspects of the present disclosure may be specifically implemented in the following forms, namely: a completely hardware implementation, a completely software implementation (including firmware, microcode, etc.), or a combined hardware and software implementation, which may be collectively referred to herein as a “circuit”, “module”, or “system”.

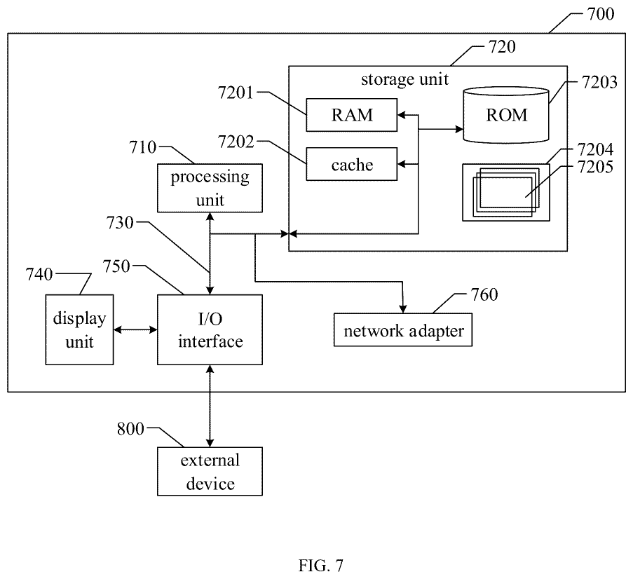

An electronic device 700 according to such an embodiment of the present disclosure will be described below with reference to FIG. 7. The electronic device 700 shown in FIG. 7 is merely an example and should not impose any limitation on the functions and usage scope of the embodiments of the present disclosure.

As shown in FIG. 7, the electronic device 700 is presented in the form of a general-purpose computing device. The components of the electronic device 700 may include, but are not limited to: at least one processing unit 710 as described above, at least one storage unit 720 as described above, a bus 730 that connects different system components (including the storage unit 720 and the processing unit 710), and a display unit 740.

The storage unit stores program code, which may be executed by the processing unit 710 such that the processing unit 710 executes the steps described in the above “exemplary method” section of this specification according to various embodiments of the present disclosure. For example, the processing unit 710 may execute steps as follows: acquiring the original image, where the original image includes a face image having the initial artistic style; pre-processing the face image to obtain facial feature data; obtaining the initial three-dimensional face model corresponding to the face image according to a preset template library and the facial feature data; extracting an initial texture map from the face images based on the facial feature data and the preset template library; and fitting the initial three-dimensional face model and the initial texture map to obtain a target three-dimensional face model.

In some embodiments, the facial feature data includes a facial feature point of the face image, and pre-processing the face image to obtain the facial feature data includes: labeling the facial feature point of the face image according to a topological wiring of the identical artistic style to obtain labeled data; adjusting a pre-trained initial facial feature point detection model according to the labeled data to obtain an adjusted target facial feature point detection model; and inputting the face image into the target facial feature point detection model to obtain the facial feature point.

In some embodiments, the facial feature data includes facial organ feature data of the face image, and pre-processing the face image to obtain the facial feature data includes: cropping the face image according to the facial feature point to obtain a cropped face image; detecting pixel coordinate information of a facial organ in the cropped face image; and taking the pixel coordinate information as the facial organ feature data.

In some embodiments, before obtaining the initial three-dimensional face model corresponding to the face image according to the preset template library and the facial feature data, the method further includes: acquiring historical character face model data, and performing retopology on the topological wiring in the historical character face model data to obtain retopologized character face model data; calculating a character facial region in the retopologized character face model data; recombining and splicing the historical character face model data through a mesh of the character facial region to obtain expanded character face model data, where the character artistic style in the historical character face model data is the same as that of the expanded character face model data; and constructing the preset template library according to the historical character face model data and the expanded character face model data.

In some embodiments, the preset template library further includes: a texture basis, and extracting the initial texture map from the face image based on the facial feature data and the preset template library includes: performing projection mapping in the face image based on the initial three-dimensional face model and the facial organ feature data to extract a two-dimensional texture map in the face image; calculating an initial texture basis coefficient according to the two-dimensional texture map and the texture basis in the preset template library; and determining the initial texture map according to the initial texture basis coefficient.

In some embodiments, the initial three-dimensional face model includes a three-dimensional face shape, and fitting the initial three-dimensional face model and the initial texture map to obtain a target three-dimensional face model includes: calculating a shape image loss between the three-dimensional face shape and the face image; calculating a texture image loss between the initial texture map and the face image; determining a shape basis coefficient of the target three-dimensional face model according to the shape image loss and the texture image loss; updating the three-dimensional face shape and the initial texture map according to the shape basis coefficient to obtain a refined texture basis coefficient; and determining the target three-dimensional face model according to the refined texture basis coefficient.

In some embodiments, the face image includes a face image under at least one view angle, the shape image loss includes a shape image loss corresponding to the face image under the at least one view angle, and the texture image loss includes a texture image loss corresponding to the face image under the at least one view angle, where the view angle includes at least one of: a front view angle, a left view angle, and a right view angle.

In some embodiments, the preset template library further includes a fixed region, and fitting the initial three-dimensional face model and the initial texture map to obtain the target three-dimensional face model includes: fitting the initial three-dimensional face model and the initial texture map to obtain an intermediate three-dimensional face model; connecting a fixed facial region in the intermediate three-dimensional face model with a fixed human body model to obtain a connected region; performing deformation processing on the connected region to obtain a target intermediate three-dimensional face model; determining a movement position of a facial organ model in the target intermediate three-dimensional face model to obtain pose data of the facial organ model; and adjusting the target intermediate three-dimensional face model according to the connected region and the pose data to obtain the target three-dimensional face model.

In some embodiments, fitting the initial three-dimensional face model and the initial texture map to obtain the target three-dimensional face model includes: acquiring the initial texture basis coefficient; determining an initial texture map through the initial texture basis coefficient; fitting the initial texture map and the initial three-dimensional face model to obtain a target texture map; if the style of the target three-dimensional face model is a preset style, refining the target texture map according to a texture model to obtain a refined texture map, where the accuracy of the refined texture map is higher than that of the target texture map; and determining the target three-dimensional face model according to the refined texture map.

The storage unit 720 may include a readable medium in the form of a volatile storage unit, such as a random access memory (RAM) 7201 and/or a cache memory unit 7202, and may further include a read-only memory (ROM) 7203.

The storage unit 720 may further include a program/utility 7204 having a set (at least one) of program modules 7205. Such program modules 7205 include, but are not limited to: an operating system, one or more application programs, other program modules, and program data, each of which in these examples, or some combination thereof, may include implementations of a networked environment.

The bus 730 may represent one or more of several types of bus structures, including a storage unit bus or a storage unit controller, a peripheral bus, a graphics acceleration port, a processing unit or local bus using any of several bus structures.

The electronic device 700 may also communicate with one or more external devices 800 (such as a keyboard, a pointing device, a Bluetooth device, and the like) and may communicate with one or more devices that enable the user to interact with the electronic device 700, and/or with any device that enables the electronic device 700 to communicate with one or more other computing devices (such as a router, modem, and the like). Such communication may be carried out through an input/output (I/O) interface 750. Moreover, the electronic device 700 may also communicate with one or more networks (such as a local area network (LAN), a wide area network (WAN), and/or a public network, such as the Internet) through a network adapter 760. As shown in the figure, the network adapter 760 communicates with other modules of the electronic device 700 through the bus 730. It should be understood that although not shown in the figure, other hardware and/or software modules may be used in conjunction with the electronic device 700, including but not limited to: a microcode, a device driver, a redundant processing unit, an external disk drive array, a RAID system, a tape drive, and a data backup storage system, and the like.

Through the description of the above implementations, it is easy for those skilled in the art to understand that the exemplary implementations described herein can be implemented through software or through a combination of software and necessary hardware. Therefore, the technical solutions according to the implementations of the present disclosure can be embodied as a software product, which can be stored in a non-volatile storage medium (such as a CD-ROM, a USB flash drive, a mobile hard disk, and the like) or on a network. The software product includes several instructions to cause a computing device (such as a personal computer, server, terminal device, or network device, etc.) to perform the methods according to the implementations of the present disclosure.

According to the electronic device provided in the optional embodiment of the present disclosure, on the one hand, by obtaining the initial three-dimensional face model corresponding to the face image according to the preset template library and face feature data, the diversity of template data in the open-source database is increased, the generation efficiency of the initial three-dimensional face model is improved, the processing efficiency of the electronic device is improved, and relevant computing resources are saved; on the other hand, by fitting the initial three-dimensional face model and the initial texture map, the accuracy of the target three-dimensional face model is improved.

In addition, the above-mentioned figures are only schematic illustrations of the processing included in the method according to the embodiments of the present disclosure, and are not for limiting purposes. It is easy to understand that the processing shown in the above-mentioned figures does not indicate or limit the time sequence of these processes. Also, it is easy to understand that these processes can be executed, for example, synchronously or asynchronously in multiple modules.

It will be readily apparent to those skilled in the art that other embodiments of the present disclosure can be easily conceived after considering the specification and practicing the invention disclosed herein. The present disclosure is intended to cover any variations, uses or adaptations of the present disclosure that follow the general principles of the present disclosure and include common knowledge or conventional techniques in the technical field of the present disclosure that are not disclosed herein. The description and examples are only considered as exemplary, and the true scope and spirit of the present disclosure are indicated by the claims.

1. A method for generating a model, comprising:
acquiring an original image, wherein the original image comprises a face image having an identical artistic style;
pre-processing the face image to obtain facial feature data;
obtaining, according to a preset template library and the facial feature data, an initial three-dimensional face model corresponding to the face image;
extracting, based on the facial feature data and the preset template library, an initial texture map from the face image; and
fitting the initial three-dimensional face model and the initial texture map to obtain a target three-dimensional face model.

2. The method according to claim 1, wherein the facial feature data comprises a facial feature point of the face image, and pre-processing the face image to obtain the facial feature data comprises:
labeling the facial feature point of the face image according to a topological wiring of the identical artistic style to obtain labeled data;
adjusting, according to the labeled data, a pre-trained initial face feature point detection model to obtain an adjusted target face feature point detection model; and
inputting the face image into the target face feature point detection model to obtain the facial feature point.

3. The method according to claim 2, wherein the facial feature data comprises facial organ feature data of the face image, and pre-processing the face image to obtain the facial feature data comprises:
cropping, according to the facial feature point, the face image to obtain a cropped face image;
detecting pixel coordinate information of a facial organ in the cropped face image; and
taking the pixel coordinate information as the facial organ feature data.

4. The method according to claim 2, wherein, the method further comprises:
acquiring historical character face model data, and performing retopology on topological wiring in the historical character face model data, to obtain retopologized character face model data;
calculating a character facial region in the retopologized character face model data;
recombining and splicing the historical character face model data through a mesh of the character facial region, to obtain expanded character face model data, wherein a character artistic style in the historical character face model data is identical to a character artistic style in the expanded character face model data; and
constructing, according to the historical character face model data and the expanded character face model data, the preset template library.

5. The method according to claim 4, wherein the preset template library comprises a shape basis and an average face model, and obtaining the initial three-dimensional face model corresponding to the face image according to the preset template library and the facial feature data comprises:
acquiring the shape basis and the average face model in the preset template library;
fitting the shape basis and the facial feature point to obtain a target shape basis; and
iteratively calculating the target shape basis and the average face model to obtain the initial three-dimensional face model.

6. The method according to claim 3, wherein the preset template library further comprises a texture basis, and extracting the initial texture map from the face image based on the facial feature data and the preset template library comprises:
performing projection mapping in the face image based on the initial three-dimensional face model and the facial organ feature data to extract a two-dimensional texture map in the face image;
calculating, according to the two-dimensional texture map and the texture basis in the preset template library, an initial texture basis coefficient; and
determining, according to the initial texture basis coefficient, the initial texture map.

7. The method according to claim 1, wherein the initial three-dimensional face model comprises a three-dimensional face shape, and fitting the initial three-dimensional face model and the initial texture map to obtain the target three-dimensional face model comprises:
calculating a shape image loss between the three-dimensional face shape and the face image;
calculating a texture image loss between the initial texture map and the face image;
determining, according to the shape image loss and the texture image loss, a shape basis coefficient of the target three-dimensional face model;
updating, according to the shape basis coefficient, the three-dimensional face shape and the initial texture map to obtain a refined texture basis coefficient; and
determining, according to the refined texture basis coefficient, the target three-dimensional face model.

8. The method according to claim 7, wherein the face image comprises a face image under at least one view angle, the shape image loss comprises a shape image loss corresponding to the face image under the at least one view angle, and the texture image loss comprises a texture image loss corresponding to the face image under the at least one view angle, wherein the view angle comprises at least one of: a front view angle, a left view angle, or a right view angle.

9. The method according to claim 1, wherein the preset template library further comprises a fixed region, the fixed region comprises a fixed facial region and a fixed human body model, and fitting the initial three-dimensional face model and the initial texture map to obtain the target three-dimensional face model comprises:
fitting the initial three-dimensional face model and the initial texture map to obtain an intermediate three-dimensional face model;
connecting the fixed facial region in the intermediate three-dimensional face model with the fixed human body model to obtain a connected region, and performing deformation processing on the connected region to obtain a target intermediate three-dimensional face model;
determining a movement position of a facial organ model in the target intermediate three-dimensional face model to obtain pose data of the facial organ model; and
adjusting, according to the connected region and the pose data, the target intermediate three-dimensional face model to obtain the target three-dimensional face model.

10. The method according to claim 6, wherein fitting the initial three-dimensional face model and the initial texture map to obtain the target three-dimensional face model comprises:
acquiring the initial texture basis coefficient;
determining the initial texture map according to the initial texture basis coefficient;
fitting the initial texture map and the initial three-dimensional face model to obtain a target texture map;
refining, in response to determining that a style of the target three-dimensional face model is a preset style, the target texture map according to a texture model to obtain a refined texture map, wherein an accuracy of the refined texture map is higher than an accuracy of the target texture map; and
determining, according to the refined texture map, the target three-dimensional face model.

11. (canceled)

12. An electronic device, comprising:
a processor; and
a memory, wherein the memory stores computer-readable instructions which, when executed by the processor, cause the processor to:
acquire an original image, wherein the original image comprises a face image having an identical artistic style;
pre-process the face image to obtain facial feature data;
obtain, according to a preset template library and the facial feature data, an initial three-dimensional face model corresponding to the face image;
extract, based on the facial feature data and the preset template library, an initial texture map from the face image; and
fit the initial three-dimensional face model and the initial texture map to obtain a target three-dimensional face model.

13. A non-transitory computer-readable storage medium, storing a computer program which, when executed by a processor, implements the method for generating the model according to claim 1.

14. The method according to claim 1, wherein the artistic style comprises one of a Chinese style, a martial arts style, a handsome realistic style, or a two-dimensional style.

15. The method according to claim 1, wherein the pre-processing operation comprises at least one of:
detecting a facial feature point of the face image;
performing cropping on the face image, or
performing segmentation on the face image.

16. The method according to claim 1, wherein the facial feature data comprises at least one of:
facial organ feature data of the face image, or
a facial feature point of the face image.

17. The method according to claim 2, wherein the facial feature point automatically detected is adjustable manually.

18. The electronic device according to claim 12, wherein the facial feature data comprises a facial feature point of the face image, and the processor is further configured to:
label the facial feature point of the face image according to a topological wiring of the identical artistic style to obtain labeled data;
adjust, according to the labeled data, a pre-trained initial face feature point detection model to obtain an adjusted target face feature point detection model; and
input the face image into the target face feature point detection model to obtain the facial feature point.

19. The electronic device according to claim 18, wherein the facial feature data comprises facial organ feature data of the face image, and the processor is further configured to:
crop, according to the facial feature point, the face image to obtain a cropped face image;
detect pixel coordinate information of a facial organ in the cropped face image; and
take the pixel coordinate information as the facial organ feature data.

20. The electronic device according to claim 18, wherein the processor is further configured to:
acquire historical character face model data, and performing retopology on topological wiring in the historical character face model data, to obtain retopologized character face model data;
calculate a character facial region in the retopologized character face model data;
recombine and splice the historical character face model data through a mesh of the character facial region, to obtain expanded character face model data, wherein a character artistic style in the historical character face model data is identical to a character artistic style in the expanded character face model data; and
construct, according to the historical character face model data and the expanded character face model data, the preset template library.

21. The electronic device according to claim 20, wherein the preset template library comprises a shape basis and an average face model, and the processor is further configured to:
acquire the shape basis and the average face model in the preset template library;
fit the shape basis and the facial feature point to obtain a target shape basis; and
iteratively calculate the target shape basis and the average face model to obtain the initial three-dimensional face model.
